(19) United States
(12) Patent Application Publication
(10) Pub. No.: US 2013/0141471 A1
(43) Pub. Date: Jun. 6, 2013

(54) OBSCURING GRAPHICAL OUTPUT ON REMOTE DISPLAYS

(71) Applicants: James D. Batson, Sunnyvale, CA (US); Bob Bradley, San Jose, CA (US); Jonathan J. Bennett, San Francisco, CA (US)

(72) Inventors: James D. Batson, Sunnyvale, CA (US); Bob Bradley, San Jose, CA (US); Jonathan J. Bennett, San Francisco, CA (US)

(73) Assignee: APPLE INC., Cupertino, CA (US)

(21) Appl. No.: 13/487,690

(22) Filed: Jun. 4, 2012

Related U.S. Application Data
(60) Provisional application No. 61/493,507, filed on Jun. 5, 2011.

(51) Int. Cl. G09G 5/00

(52) U.S. Cl. CPC G09G 5/00
USPC 345/690; 345/204

(57) ABSTRACT

The disclosed embodiments provide a system that facilitates interaction between an electronic device and a remote display. The system includes a first application and an encoding apparatus on the electronic device, and a second application and a decoding apparatus on the remote display. The first application obtains graphical output for a display of the electronic device and a set of filtering parameters associated with the graphical output. Next, the encoding apparatus encodes the graphical output, and the first application transmits the graphical output and the filtering parameters to the remote display. Upon receiving the graphical output and the filtering parameters at the remote display, the decoding apparatus decodes the graphical output. The second application then uses the graphical output to drive the remote display and the filtering parameters to obscure a subset of the graphical output on the remote display.

### RELATED APPLICATION

This application hereby claims priority under 35 U.S.C. §119 to U.S. Provisional Application No. 61/493,507, entitled “Obscuring Graphical Output on Remote Displays,” by James D. Batson, filed 5 Jun. 2011 (Atty. Docket No.: APL-P11241USP1).

### BACKGROUND

1. Field

The present embodiments relate to techniques for driving remote displays. More specifically, the present embodiments relate to techniques for obscuring graphical output from an electronic device on a remote display.

2. Related Art

Modern portable electronic devices typically include functionality to create, store, open, and/or update various forms of digital media. For example, a mobile phone may include a camera for capturing images, memory in which images may be stored, software for viewing images, and/or software for editing images. Moreover, the portability and convenience associated with portable electronic devices allows users of the portable electronic devices to incorporate digital media into everyday activities. For example, the camera on a mobile phone may allow a user of the mobile phone to take pictures at various times and in multiple settings, while the display screen on the mobile phone and installed software may allow the user to display the pictures to others.

However, size and resource limitations may prevent users of portable electronic devices from effectively sharing media on the portable electronic devices. For example, the display screen on a tablet computer may be too small to be used in a presentation to a large group of people. Instead, the user of the tablet computer may conduct the presentation by driving a large remote display using a screen sharing application on the tablet computer.

Hence, what is needed is a mechanism for facilitating the sharing of media from a portable electronic device.

### SUMMARY

The disclosed embodiments provide a system that facilitates interaction between an electronic device and a remote display. The system includes a first application and an encoding apparatus on the electronic device, and a second application and a decoding apparatus on the remote display. The first application obtains graphical output for a display of the electronic device and a set of filtering parameters associated with the graphical output. Next, the encoding apparatus encodes the graphical output, and the first application transmits the graphical output and the filtering parameters to the remote display. Upon receiving the graphical output and the filtering parameters at the remote display, the decoding apparatus decodes the graphical output. The second application then uses the graphical output to drive the remote display and the filtering parameters to obscure a subset of the graphical output on the remote display.

In some embodiments, using the filtering parameters to obscure the subset of the graphical output on the remote display involves at least one of:
(i) freezing the graphical output;
(ii) blurring the subset of the graphical output;
(iii) omitting the subset of the graphical output; and
(iv) generating a graphical overlay over the subset of the graphical output.

In some embodiments, the first application also obtains audio output associated with the graphical output and transmits the audio output to the remote display. Upon receiving the audio output, the second application uses the audio output to drive an audio output device associated with the remote display and the filtering parameters to obscure a subset of the audio output on the audio output device.

In some embodiments, using the filtering parameters to obscure the subset of the audio output on the audio output device involves at least one of:

(i) muting the subset of the audio output;

(ii) distorting the subset of the audio output; and

(iii) using substitute audio output to drive the audio output device.

In some embodiments, each of the filtering parameters is associated with at least one of a timestamp, a frame of the graphical output, an obscuring mode, a user-interface element, and a region of the graphical output. In addition, the filtering parameters may be obtained from a user of the electronic device and/or the first application. Finally, the filtering parameters may be based on a security policy associated with the graphical output, a privacy policy associated with the graphical output, and/or a region of interest in the graphical output.

In some embodiments, the electronic device is at least one of a mobile phone, a tablet computer, and a portable media player.

### BRIEF DESCRIPTION OF THE FIGURES

FIG. 1 shows a schematic of a system in accordance with an embodiment.

FIG. 2 shows a system for facilitating interaction between an electronic device and a remote display in accordance with an embodiment.

FIG. 3 shows an exemplary interaction between an electronic device and a remote display in accordance with an embodiment.

FIG. 4 shows an exemplary interaction between an electronic device and a remote display in accordance with an embodiment.

FIG. 5 shows a flowchart illustrating the process of driving a remote display in accordance with an embodiment.

FIG. 6 shows a flowchart illustrating the process of interacting with an electronic device in accordance with an embodiment.

FIG. 7 shows a computer system in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

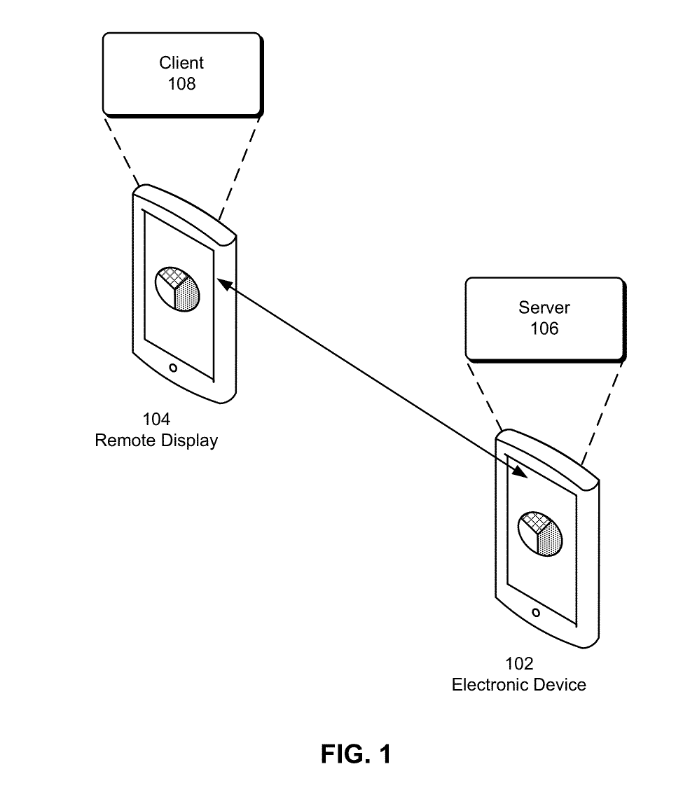

FIG. 1 shows a schematic of a system in accordance with an embodiment. The system includes an electronic device 102 and a remote display 104. Electronic device 102 may correspond to a mobile phone, tablet computer, portable media player, and/or other compact electronic device that includes functionality to store digital media such as documents, images, audio, and/or video. Remote display 104 may also correspond to a compact electronic device such as a tablet computer, mobile phone, and/or portable media player, or remote display 104 may include a projector, monitor, and/or other type of electronic display that is external to and/or larger than a display on electronic device 102.

In one or more embodiments, remote display 104 facilitates the sharing of digital media from electronic device 102. In particular, electronic device 102 may be used to drive remote display 104 so that graphical output on remote display 104 is substantially the same as graphical output on electronic device 102. For example, a user of electronic device 102 may control the display of a photo slideshow, presentation, and/or document on both remote display 104 and electronic device 102 from an application on electronic device 102. Because remote display 104 provides additional space for displaying the graphical output, remote display 104 may allow the photo slideshow, presentation, and/or document to be viewed by more people than if the photo slideshow, presentation, and/or document were displayed only on electronic device 102.

To enable the driving of remote display 104 from electronic device 102, a server 106 on electronic device 102 may be used to communicate with a client 108 on remote display 104. Server 106 may transmit graphical output from electronic device 102 to client 108, and client 108 may update remote display 104 with the graphical output. For example, server 106 and client 108 may correspond to a remote desktop server and remote desktop client that communicate over a network connection between electronic device 102 and remote display 104. The remote desktop server may propagate changes to the desktop and/or display of electronic device 102 to the remote desktop client, and the remote desktop client may update remote display 104 accordingly. In other words, server 106 and client 108 may allow electronic device 102 to drive remote display 104 without connecting to remote display 104 using a video interface such as Digital Visual Interface (DVI), High-Definition Multimedia Interface (HDMI), and/or DisplayPort.

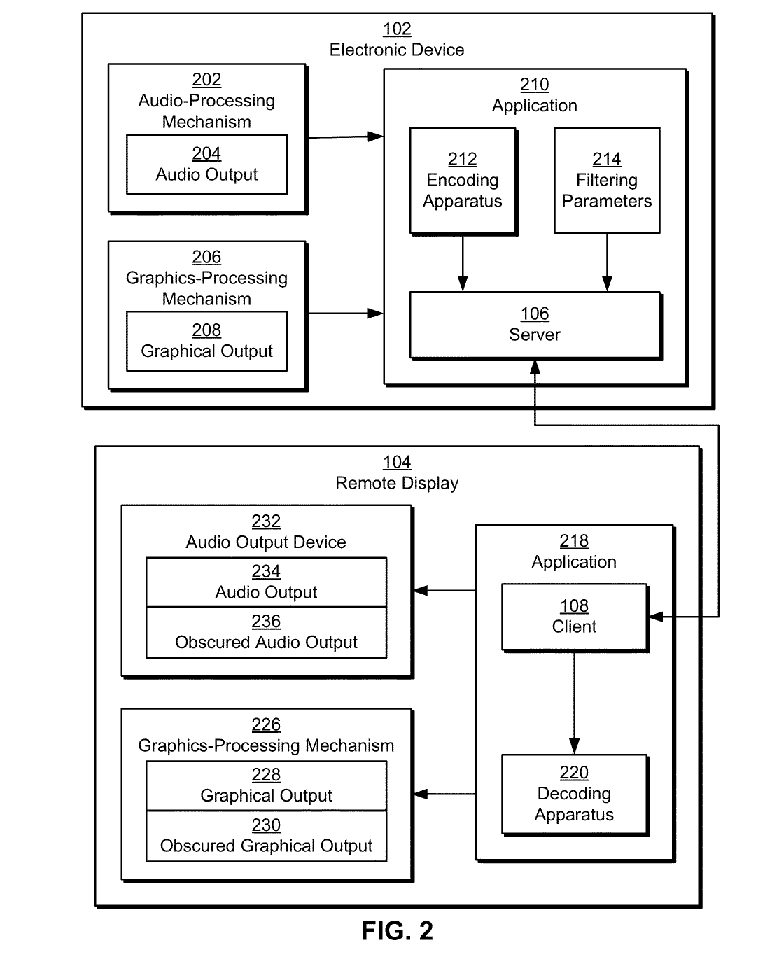

Server 106 and client 108 may additionally be configured to obscure a subset of the graphical output on remote display 104 using a set of filtering parameters associated with the graphical output. As discussed in further detail below with respect to FIG. 2, a first application associated with server 106 may generate the filtering parameters. Each of the filtering parameters may be associated with a timestamp, a frame of the graphical output, an obscuring mode, a user-interface element, and/or a region of the graphical output. In addition, the filtering parameters may be generated based on a security policy associated with the graphical output, a privacy policy associated with the graphical output, and/or a region of interest in the graphical output.

Next, server 106 may transmit the graphical output and filtering parameters to remote display 104. A second application associated with client 108 may then use the graphical output to drive remote display 104. In addition, the second application may use the filtering parameters to obscure a subset of the graphical output on remote display 104. For example, the second application may obscure the subset of the graphical output by freezing the graphical output, blurring the subset of the graphical output, omitting the subset of the graphical output, and/or generating a graphical overlay over the subset of the graphical output.

Server 106 may additionally transmit audio output associated with the graphical output to remote display 104, and the second application may use the audio output to drive an audio output device associated with remote display 104. Furthermore, the second application may use the filtering parameters to obscure a subset of the audio output on the audio output device. For example, the second application may obscure the subset of the audio output by muting the subset of the audio output, distorting the subset of the audio output, and/or using substitute audio output to drive the audio output device. Consequently, the first and second applications may improve the security, privacy, and/or relevance of digital media used to drive remote display 104 from electronic device 102.

FIG. 2 shows a system for facilitating interaction between electronic device 102 and remote display 104 in accordance with an embodiment. As described above, electronic device 102 may drive remote display 104 so that graphical output 208 on electronic device 102 is substantially the same as graphical output 228 on remote display 104. For example, electronic device 102 may enable the display of a presentation, photo slideshow, and/or document on both remote display 104 and the display of electronic device 102.

To drive remote display 104 from electronic device 102, a first application 210 associated with server 106 may generate graphical output 208 using a graphics-processing mechanism 206 (e.g., graphics-processing unit (GPU), graphics stack, etc.) in electronic device 102. For example, application 210 may issue draw commands to graphics-processing mechanism 206 to generate text, images, user-interface elements, animations, and/or other graphical output 208 that is shown within a display of electronic device 102.

After graphical output 208 is generated by graphics-processing mechanism 206, graphical output 208 may be obtained by application 210 and encoded by an encoding apparatus 212 associated with application 210. During encoding, encoding apparatus 212 may convert graphical output 208 from a first color space to a second color space and/or scale graphical output 208. For example, encoding apparatus 212 may include functionality to encode graphical output 208 using an H.264 codec. As a result, encoding apparatus 212 may convert graphical output 208 from an RGB color space into a YUV color space. Encoding apparatus 212 may also scale graphical output 208 up or down to allow graphical output 208 to match the resolution of remote display 104.

Once graphical output 208 is encoded, server 106 may transmit graphical output 208 to client 108 over a network (e.g., wireless network, local area network (LAN), wide area network (WAN), etc.) connection. A second application 218 associated with client 108 may then use graphical output 208 to update remote display 104. More specifically, a decoding apparatus 220 associated with application 218 may decode graphical output 208. For example, decoding apparatus 220 may include an H.264 codec that obtains frames of pixel values from the encoded graphical output 208. The pixel values may then be sent to a graphics-processing mechanism 226 (e.g., GPU, graphics stack) in remote display 104 and used by graphics-processing mechanism 226 to generate graphical output 228 for driving remote display 104.

As mentioned previously, applications 210 and 218 may include functionality to obscure a subset of graphical output 208 on remote display 104. In particular, application 210 may generate a set of filtering parameters 214 associated with graphical output 208. Filtering parameters 214 may be based on a security policy associated with graphical output 208, a privacy policy associated with graphical output 208, and/or a region of interest in graphical output 208. For example, filtering parameters 214 may be used to identify portions of graphical output 208 containing sensitive information such as usernames, passwords, account numbers, personally identifiable information, gestures, and/or classified information. Filtering parameters 214 may also be used to identify regions of graphical output 208 selected and/or highlighted by a user of application 210 and/or electronic device 102.

Server 106 may then transmit filtering parameters 214 along with graphical output 208 to client 108. For example, graphical output 208 may be transmitted through a main communication channel between server 106 and client 108, and filtering parameters 214 may be transmitted through a sideband channel between server 106 and client 108. Upon receiving filtering parameters 214, application 218 and/or graphics-processing mechanism 226 may use filtering parameters 214 to generate obscured graphical output 230 that is used to drive remote display 104 in lieu of a subset of graphical output 208. In other words, a frame of graphical output 208 may be shown on remote display 104 as a frame containing both graphical output 228 and obscured graphical output 230, with obscured graphical output 230 substituted for one or more portions of graphical output 208 specified in filtering parameters 214.

In one or more embodiments, obscured graphical output 230 corresponds to one or more portions of graphical output 208 identified by filtering parameters 214. That is, obscured graphical output 230 may be used to obscure one or more portions of graphical output 208 containing sensitive, secure, private, and/or irrelevant information. To enable such obscuring of graphical output 208, each filtering parameter may be associated with a timestamp, a frame of graphical output 208, an obscuring mode, a user-interface element, and/or a region of graphical output 208. First, a timestamp and/or frame number may be included with the filtering parameter to synchronize generation of obscured graphical output 230 from the filtering parameter and graphical output 208 with the use of graphical output 208 to drive remote display 104. Similarly, the filtering parameter may specify the portion of graphical output 208 to be obscured as a user-interface element (e.g., form field, button, list element, text box, virtual keyboard, etc.) and/or region of graphical output 208 (e.g., rectangle, circle, polygon, set of pixels).

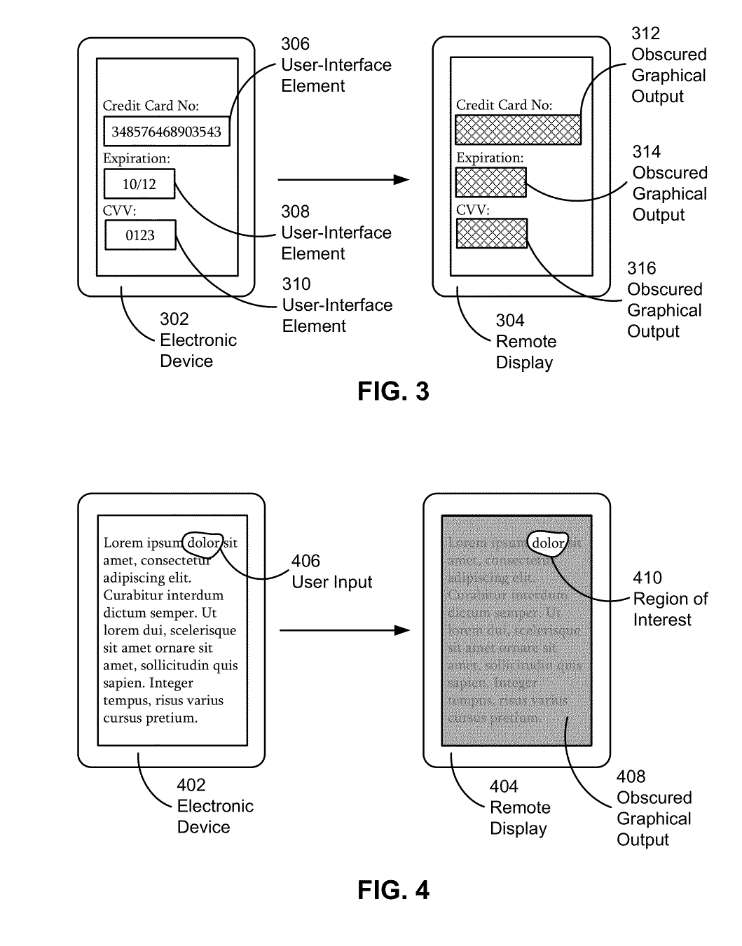

Finally, an obscuring mode for the filtering parameter may indicate the method of obscuring the subset of graphical output 208 on remote display 104. For example, the obscuring mode may specify the generation of obscured graphical output 230 through the freezing of graphical output 208, blurring of the subset of graphical output 208, omission of the subset of graphical output 208, and/or the generation of a graphical overlay over graphical output 208. Generation of obscured graphical output 230 from graphical output 208 and filtering parameters 214 is discussed in further detail below with respect to FIGS. 3-4.

Applications 210 and 218 may also be used to obscure a subset of audio output 204 from electronic device 102 on an audio output device 232 (e.g., speakers, headphones, etc.) associated with remote display 104. For example, applications 210 and 218 may enforce a security and/or privacy policy associated with audio output 204 by obscuring one or more portions of audio output 204 containing sensitive, secure, private, and/or confidential information on audio output device 232. Applications 210 and 218 may additionally obscure portions of audio output 204 deemed unimportant and/or irrelevant by the user of electronic device 102 and/or application 210.

First, application 210 may generate audio output 204 using an audio-processing mechanism 202 (e.g., processor) in electronic device 102. Audio output 204 may then be encoded by encoding apparatus 212 (e.g., using an Advanced Audio Coding (AAC) codec) and transmitted by server 106 to remote display 104. Once audio output 204 is received by client 108, decoding apparatus 220 may decode audio output 204, and application 218 may use the decoded audio output to generate audio output 234 on audio output device 232.

Furthermore, application 218 may use one or more filtering parameters 214 to generate obscured audio output 236 that is used to drive audio output device 232 in lieu of a subset of audio output 204. As with graphical output 208, each filtering parameter used to obscure audio output 204 may be associated with timing information, identifying information, and/or obscuring modes. For example, application 218 may use one or more timestamps associated with the filtering parameter to begin and end the generation of obscured audio output 236. Application 218 may also use an audio track number associated with the filtering parameter to identify the audio track to be obscured. Finally, application 218 may use an obscuring mode associated with filtering parameters 214 to mute audio output 204, distort audio output 204, use substitute audio output in lieu of audio output 204, and/or otherwise generate obscured audio output 236.

Consequently, applications 210 and 218 may facilitate the sharing of graphical and/or audio output between electronic device 102 and remote display 104 without compromising the security and/or privacy of information in the graphical and/or audio output. Applications 210 and 218 may additionally facilitate the presentation of relevant information on remote display 104 by allowing the user of electronic device 102 to selectively obscure portions of the graphical and/or audio output on remote display 104.

Those skilled in the art will appreciate that the system of FIG. 2 may be implemented in a variety of ways. First, encoding apparatus 212 and server 106 may execute within application 210 and/or independently of application 210. Along the same lines, decoding apparatus 220 and client 108 may execute within application 218 and/or independently of application 218. Moreover, applications 210 and 218 may correspond to identical applications that each implement encoding apparatus 212, server 106, client 108, and decoding apparatus 220 to enable the driving of either electronic device 102 or remote display 104 using graphical and/or audio output from the other device. On the other hand, applications 210 and 218 may occupy complementary roles, such that electronic device 102 cannot be driven by graphical and/or audio output from remote display 104.

FIG. 3 shows an exemplary interaction between an electronic device 302 and a remote display 304 in accordance with an embodiment. Electronic device 302 may be used to drive remote display 304 so that graphical output on remote display 304 is substantially the same as graphical output on electronic device 302. For example, graphical output for a display of electronic device 302 may be transmitted to remote display 304 and used to drive remote display 304.

In addition, a number of user-interface elements 306-310 (e.g., form fields, text boxes, etc.) in electronic device 302 may be shown as obscured graphical output 312-316 on remote display 304. Such obscuring of user-interface elements 306-310 on remote display 304 may be based on a security and/or privacy policy associated with the graphical output. For example, the security and/or privacy policy may identify the credit card number (e.g., “348576468903543”), credit card expiration date (e.g., “ 10/12”), and/or card verification number (e.g., “0123”) shown in user-interface elements 306-310, respectively, as sensitive and/or private information. If a virtual keyboard is overlaid onto one or more user-interface elements 306-310, the virtual keyboard may also be obscured to prevent the information associated with user-interface elements 306-310 from being shown as the information is inputted using the virtual keyboard. As a result, obscured graphical output 312-316 may be generated in lieu of user-interface elements 306-310 and/or other user-interface elements on remote display to maintain the security, privacy, and/or confidentiality of the information in user-interface elements 306-310.

To generate obscured graphical output 312-316, an application on electronic device 302 may generate a set of filtering parameters associated with user-interface elements 306-310. Each filtering parameter may identify a user-interface element (e.g., 306-310) and/or region of graphical output to be obscured. As a result, the application may generate three filtering parameters that flag user-interface elements 306-310 for filtering and/or obscuring.

The application may also include an obscuring mode for each filtering parameter that indicates the method by which the corresponding user-interface element 306-310 is to be obscured. For example, the application may specify the obscuring of user-interface elements 306-310 on remote display 304 through the freezing of the graphical output, blurring of the subset of the graphical output corresponding to user-interface elements 306-310, omission of the subset of the graphical output, and/or the generation of a graphical overlay over the subset of the graphical output.

The application may then transmit the graphical output and filtering parameters to remote display 304, where the filtering parameters are used by remote display 304 to obscure user-interface elements 306-310 using obscured graphical output 312-316. For example, remote display 304 may generate obscured graphical output 312-316 by freezing, blurring, omitting, and/or generating graphical overlays over user-interface elements 306-310 based on the filtering parameters.

FIG. 4 shows an exemplary interaction between an electronic device 402 and a remote display 404 in accordance with an embodiment. Like electronic device 302 and remote display 304 of FIG. 3, electronic device 402 may be used to drive remote display 404 so that graphical output is substantially the same on both electronic device 402 and remote display 404.

Furthermore, user input 406 on electronic device 402 may be used to generate a region of interest 410 and a region of obscured graphical output 408 on remote display 404. User input 406 may be associated with a touch-based gesture such as a tracing gesture, a pinching gesture, and/or a tapping gesture on a touch screen of electronic device 402. For example, a user may draw a circle corresponding to user input 406 on the touch screen to select, highlight, and/or emphasize the portion of the graphical output within the circle (e.g., “dolor”).

Once user input 406 is provided, an application on electronic device 402 may generate one or more filtering parameters associated with user input 406. The filtering parameter(s) may identify the time at which user input 406 was provided, the region of graphical output associated with user input 406, and/or the obscuring mode to be used in obscuring the subset of graphical output on remote display 404 based on user input 406.

Once the graphical output and filtering parameter(s) are received by remote display 404, remote display 404 may obscure the portion of graphical output outside region of interest 410 by generating obscured graphical output 408. For example, remote display 404 may produce obscured graphical output 408 by blurring, omitting, and/or generating an overlay over the portion of graphical output outside region of interest 410. Conversely, remote display 404 may reproduce the graphical output from electronic device 402 within region of interest 410 to allow the user to emphasize the contents of region of interest 410 on remote display 404.

After the user is finished with region of interest 410, the user may remove obscured graphical output 408 from remote display 404 by providing additional user input on electronic device 402. For example, the user may resume the driving of remote display 404 so that graphical output is substantially the same on both electronic device 402 and remote display 404 by performing a swiping gesture, multi-touch gesture, and/or other touch-based gesture on the touch screen of electronic device 402.

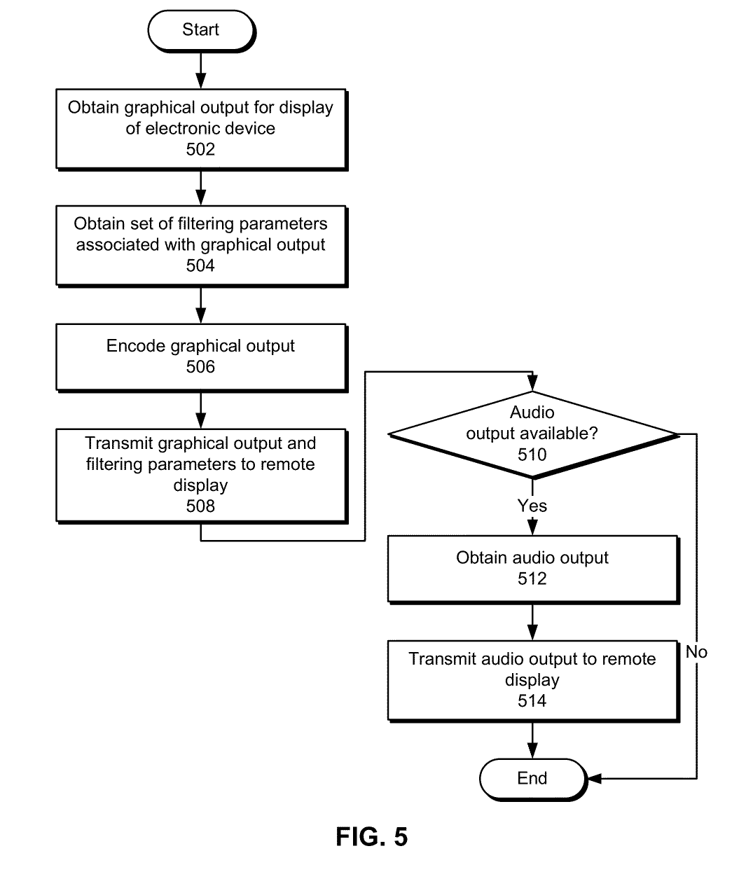

FIG. 5 shows a flowchart illustrating the process of driving a remote display in accordance with an embodiment. In one or more embodiments, one or more of the steps may be omitted, repeated, and/or performed in a different order. Accordingly, the specific arrangement of steps shown in FIG. 5 should not be construed as limiting the scope of the embodiments.

First, graphical output for a display of an electronic device is obtained (operation 502), and a set of filtering parameters associated with the graphical output is obtained (operation 504). The filtering parameters may be associated with a security policy, privacy policy, and/or region of interest in the graphical output.

Next, the graphical output is encoded (operation 506). For example, the graphical output may be encoded using an H.264 codec that converts the graphical output from a first color space to a second color space and/or scales the graphical output. The graphical output and filtering parameters are then transmitted to the remote display (operation 508), where the filtering parameters are used by the remote display to obscure a subset of the graphical output on the remote display.

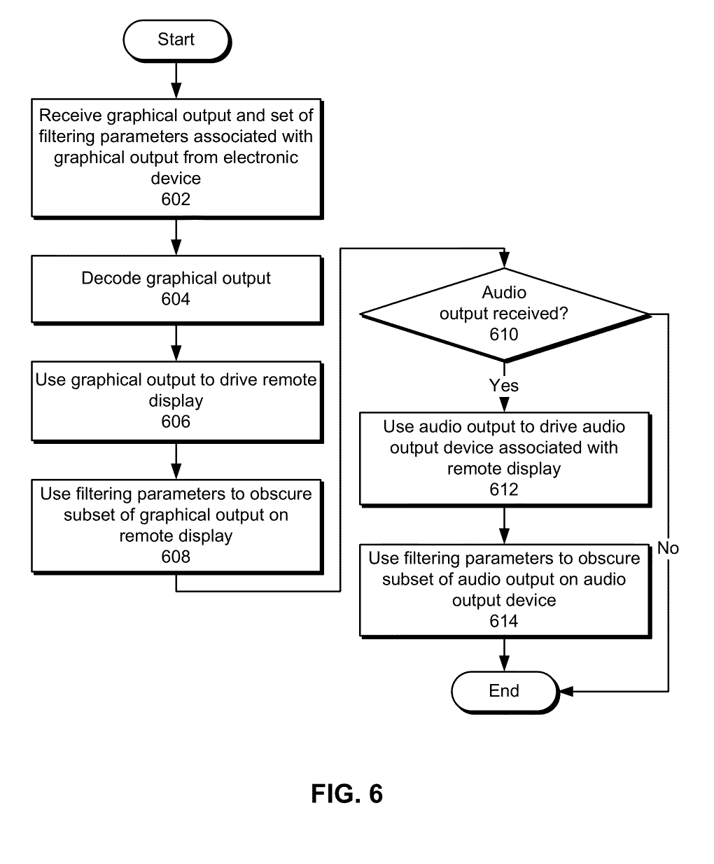

Audio output may also be available (operation 510) for use in driving the remote display from the electronic device. If audio output is not available, only graphical output may be transmitted to the remote display. If audio output is available, the audio output is obtained (operation 512) and transmitted to the remote display (operation 514), where the filtering parameters are further used by the remote display to obscure a subset of the audio output on an audio output device associated with the remote display. Use of filtering parameters to obscure a subset of graphical output and/or audio output on the remote display is discussed in further detail below with respect to FIG. 6.

FIG. 6 shows a flowchart illustrating the process of interacting with an electronic device in accordance with an embodiment. In one or more embodiments, one or more of the steps may be omitted, repeated, and/or performed in a different order. Accordingly, the specific arrangement of steps shown in FIG. 5 should not be construed as limiting the scope of the embodiments.

Initially, graphical output and a set of filtering parameters associated with the graphical output are received from the electronic device (operation 602). Next, the graphical output is decoded (operation 604). For example, an H.264 codec may be used to obtain frames of pixel values from the graphical output. The graphical output may then be used to drive the remote display (operation 606), while the filtering parameters may be used to obscure a subset of the graphical output on the remote display (operation 608). Each of the filtering parameters may be associated with a timestamp, a frame of the graphical output, an obscuring mode, a user-interface element, and/or a region of the graphical output.

In particular, timestamps and/or frame numbers from the filtering parameters may be used to synchronize obscuring of the subset of the graphical output with driving of the remote display using the graphical output. The filtering parameters may also specify user-interface elements and/or regions of the graphical output to be obscured to effectively prevent the recovery of sensitive and/or private information within the user-interface elements and/or regions. For example, the filtering parameters may specify the obscuring of a region corresponding to an entire virtual keyboard and/or a gesture area associated with an authentication gesture to prevent recovery of sensitive and/or private information during user interaction with the virtual keyboard and/or gesture area. Finally, the obscuring mode may indicate the use of freezing, blurring, omitting, and/or graphical overlays to obscure the subset of the graphical output.

Audio output may also be received (operation 610) from the electronic device. If audio output is not received, only the graphical output and/or filtering parameters may be used to drive the remote display. If audio output is received, the audio output is used to drive an audio output device associated with the remote display (operation 612), and the filtering parameters are further used to obscure a subset of the audio output on the audio output device (operation 614). For example, the filtering parameters may be used to obscure the subset of the audio output by muting the subset of the audio output, distorting the subset of the audio output, and/or using substitute audio output to drive the audio output device.

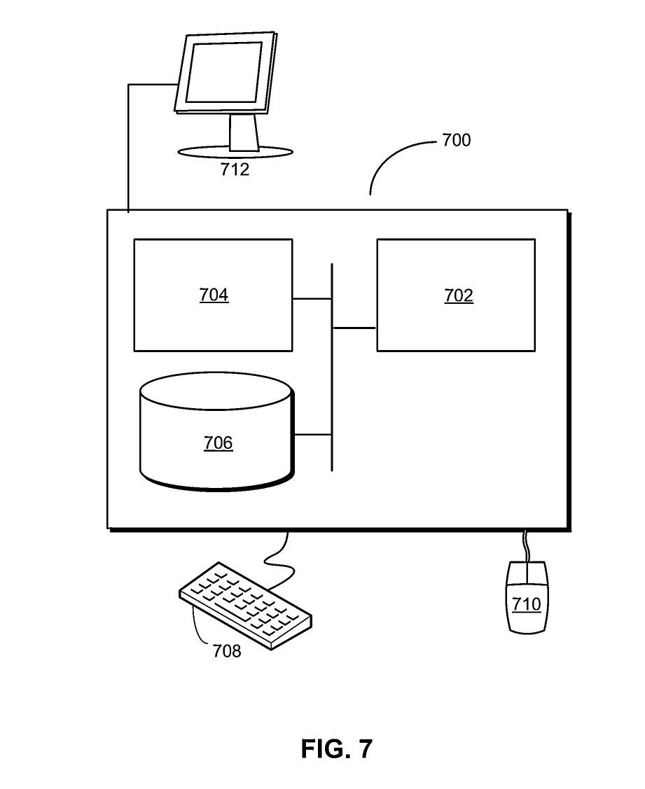

FIG. 7 shows a computer system 700 in accordance with an embodiment. Computer system 700 may correspond to an apparatus that includes a processor 702, memory 704, storage 706, and/or other components found in electronic computing devices. Processor 702 may support parallel processing and/or multi-threaded operation with other processors in computer system 700. Computer system 700 may also include input/output (I/O) devices such as a keyboard 708, a mouse 710, and a display 712.

Computer system 700 may include functionality to execute various components of the present embodiments. In particular, computer system 700 may include an operating system (not shown) that coordinates the use of hardware and software resources on computer system 700, as well as one or more applications that perform specialized tasks for the user. To perform tasks for the user, applications may obtain the use of hardware resources on computer system 700 from the operating system, as well as interact with the user through a hardware and/or software framework provided by the operating system.

In one or more embodiments, computer system 700 provides a system for facilitating interaction between an electronic device and a remote display. The system may include a first application and an encoding apparatus on the electronic device, and a second application and a decoding apparatus on the remote display. The first application may obtain graphical output for a display of the electronic device and a set of filtering parameters associated with the graphical output. The encoding apparatus may encode the graphical output, and the first application may transmit the graphical output and the filtering parameters to the remote display. Upon receiving the graphical output and the filtering parameters at the remote display, the decoding apparatus may decode the graphical output. The second application may then use the graphical output to drive the remote display and the filtering parameters to obscure a subset of the graphical output on the remote display.

In addition, the first application may obtain audio output associated with the graphical output and transmit the audio output to the remote display. Upon receiving the audio output, the second application may use the audio output to drive an audio output device associated with the remote display and the filtering parameters to obscure a subset of the audio output on the audio output device.

In addition, one or more components of computer system 700 may be remotely located and connected to the other components over a network. Portions of the present embodiments (e.g., first application, second application, encoding apparatus, decoding apparatus, etc.) may also be located on different nodes of a distributed system that implements the embodiments. For example, the present embodiments may be implemented using a cloud computing system that communicates with the electronic device using a network connection with the electronic device and displays graphical output from the electronic device on a set of remote displays.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for driving a remote display, comprising:
obtaining graphical output for a display of an electronic device;
obtaining a set of filtering parameters associated with the graphical output; and
transmitting the graphical output and the filtering parameters to the remote display, wherein the filtering parameters are used by the remote display to obscure a subset of the graphical output on the remote display.

2. The computer-implemented method of claim 1, further comprising:
encoding the graphical output prior to transmitting the graphical output to the remote display.

3. The computer-implemented method of claim 2, wherein encoding the graphical output involves at least one of:
converting the graphical output from a first color space to a second color space; and
scaling the graphical output.

4. The computer-implemented method of claim 1, further comprising:
obtaining audio output associated with the graphical output; and
transmitting the audio output to the remote display, wherein the filtering parameters are further used by the remote display to obscure a subset of the audio output on an audio output device associated with the remote display.

5. The computer-implemented method of claim 1, wherein each of the filtering parameters is associated with at least one of a timestamp, a frame of the graphical output, an obscuring mode, a user-interface element, and a region of the graphical output.

6. The computer-implemented method of claim 1, wherein the filtering parameters are obtained from at least one of a user of the electronic device and an application associated with the graphical output.

7. The computer-implemented method of claim 1, wherein the electronic device is at least one of a mobile phone, a tablet computer, and a portable media player.

8. A computer-implemented method for interacting with an electronic device, comprising:
receiving graphical output and a set of filtering parameters associated with the graphical output from the electronic device;
using the graphical output to drive a remote display; and
using the filtering parameters to obscure a subset of the graphical output on the remote display.

9. The computer-implemented method of claim 8, further comprising:
decoding the graphical output prior to using the graphical output to drive the remote display.

10. The computer-implemented method of claim 8, further comprising:
receiving audio output associated with the graphical output from the electronic device;
using the audio output to drive an audio output device associated with the remote display; and
using the filtering parameters to obscure a subset of the audio output on the audio output device.

11. The computer-implemented method of claim 10, wherein using the filtering parameters to obscure the subset of the audio output on the audio output device involves at least one of:
muting the subset of the audio output;
distorting the subset of the audio output; and
using substitute audio output to drive the audio output device.

12. The computer-implemented method of claim 8, wherein using the filtering parameters to obscure the subset of the graphical output on the remote display involves at least one of:
freezing the graphical output;
blurring the subset of the graphical output;
omitting the subset of the graphical output; and
generating a graphical overlay over the subset of the graphical output.

13. The computer-implemented method of claim 8, wherein each of the filtering parameters is associated with at least one of a timestamp, a frame of the graphical output, an obscuring mode, a user-interface element, and a region of the graphical output.

14. A system for facilitating interaction between an electronic device and a remote display, comprising:
a first application on the electronic device, wherein the first application is configured to:
obtain graphical output for a display of the electronic device;
generate a set of filtering parameters associated with the graphical output; and
transmit the graphical output and the filtering parameters to the remote display; and
a second application on the remote display, wherein the second application is configured to:
use the graphical output to drive a remote display; and
use the filtering parameters to obscure a subset of the graphical output on the remote display.

15. The system of claim 14, further comprising:
an encoding apparatus on the electronic device, wherein the encoding apparatus is configured to encode the graphical output prior to transmitting the graphical output to the remote display; and
a decoding apparatus on the remote display, wherein the decoding apparatus is configured to decode the graphical output prior to using the graphical output to drive the remote display.

16. The system of claim 14,
wherein the first application is further configured to:
obtain audio output associated with the graphical output; and
transmit the audio output to the remote display, and
wherein the second application is further configured to:
use the audio output to drive an audio output device associated with the remote display; and
use the filtering parameters to obscure a subset of the audio output on the audio output device.

17. The system of claim 16, wherein further using the filtering parameters to obscure the subset of the audio output on the audio output device involves at least one of:
muting the subset of the audio output;
distorting the subset of the audio output; and
using substitute audio output to drive the audio output device.

18. The system of claim 14, wherein using the filtering parameters to obscure the subset of the graphical output on the remote display involves at least one of:
freezing the graphical output;
blurring the subset of the graphical output;
omitting the subset of the graphical output; and
generating a graphical overlay over the subset of the graphical output.

19. The system of claim 14, wherein each of the filtering parameters is associated with at least one of a timestamp, a frame of the graphical output, an obscuring mode, a user-interface element, and a region of the graphical output.

20. The system of claim 14, wherein the filtering parameters are generated by the application based on at least one of a security policy associated with the graphical output, a privacy policy associated with the graphical output, and a region of interest in the graphical output.

21. A computer-readable storage medium storing instructions that when executed by a computer cause the computer to perform a method for interacting with an electronic device, the method comprising:
receiving graphical output and a set of filtering parameters associated with the graphical output from the electronic device;
using the graphical output to drive a remote display; and
using the filtering parameters to obscure a subset of the graphical output on the remote display.

22. The computer-readable storage medium of claim 21, the method further comprising:
receiving audio output associated with the graphical output from the electronic device;
using the audio output to drive an audio output device associated with the remote display; and
using the filtering parameters to obscure a subset of the audio output on the audio output device.

23. The computer-readable storage medium of claim 22, wherein using the filtering parameters to obscure the subset of the audio output on the audio output device involves at least one of:
muting the subset of the audio output;
distorting the subset of the audio output; and
using substitute audio output to drive the audio output device.

24. The computer-readable storage medium of claim 21, wherein using the filtering parameters to obscure the subset of the graphical output on the remote display involves at least one of:
freezing the graphical output;
blurring the subset of the graphical output;
omitting the subset of the graphical output; and
generating a graphical overlay over the subset of the graphical output.

25. The computer-readable storage medium of claim 21, wherein each of the filtering parameters is associated with at least one of a timestamp, a frame of the graphical output, an obscuring mode, a user-interface element, and a region of the graphical output.
